(19) United States
(12) Patent Application Publication
(10) Pub. No.: US 2023/0103201 A1
(43) Pub. Date: Mar. 30, 2023

(54) METHOD AND APPARATUS FOR CONTENT CACHING OF CONTENTS STORE IN NDN

(71) Applicant: ELECTRONICS AND TELECOMMUNICATIONS RESEARCH INSTITUTE, Daejeon (KR)

(72) Inventors: Yong Yoon SHIN, Daejeon (KR); Nam Seok KO, Daejeon (KR); Sae Hyong PARK, Daejeon (KR)

(73) Assignee: ELECTRONICS AND TELECOMMUNICATIONS RESEARCH INSTITUTE, Daejeon (KR)

(21) Appl. No.: 17/888,883

(22) Filed: Aug. 16, 2022

(30) Foreign Application Priority Data
Sep. 30, 2021 (KR) 10-2021-0129749

(51) Int. Cl. H04L 67/568; H04L 67/1097

(52) U.S. Cl. CPC H04L 67/568; H04L 67/1097

(57) ABSTRACT

Disclosed herein is a method for content caching in an individual node constituting a named data networking system, and an individual node determines whether or not to store data in its CS based on a node count and a cache level and based on a determination result, delivers the data to a next node after storing or without storing the data in a CS.

### CROSS REFERENCE TO RELATED APPLICATION

The present application claims priority to Korean application No. KR 10-2021-0129749, filed Sep. 30, 2021, the entire contents of which are incorporated herein for all purposes by this reference.

### BACKGROUND OF THE INVENTION

### Field of the Invention

The present disclosure relates to a method and apparatus for content caching, and more particularly, to a method and apparatus for content caching of a contents store in NDN.

### Description of the Related Art

Named data networking (NDN) is used as the same concept as content centric networking (CCN) and is one of embodiment cases for future networks discussed in information centric networking (ICN).

In NDN, a content is constructed as a set of segments and responds to an interest(request) by means of data. In order to improve network performance, NDN caches (temporarily stores) a data packet of a node in a downstream network path. This feature provides a benefit of providing data about an interest more quickly.

Currently, various factors for such cache management are being considered in clouds, and the most basic factors are a short response time and the efficiency of contents storage. The cache management of NDN focuses on a quick data response to an interest, which may match the main factor of short response time. In addition, efficiency is provided by caching frequently-requested data.

In the case of a conventional NDN technology, preference is given to the cache strategy of storing as much data as possible in individual nodes and of allocating it to as many networks as possible. A method of storing as many contents as possible in the contents store (CS) of every node located in a network requires a massive storage space, and as cached data increases, an extensive search occurs, and this method has a problem of high possibility of increasing the burden of a node.

### SUMMARY OF THE INVENTION

The present disclosure is directed to provide a method and system for content caching, in which an individual node determines whether or not to store data in its CS based on a node count and a cache level and, based on a determination result, delivers the data to a next node after storing or without storing the data in a CS.

The present disclosure is directed to provide a method and system for content caching which, when a consumer is added to a specific node, designate a pending interest table (PIT) level and store data in a CS adjacent to the consumer requesting data based on a PIT level and PIT frequency of a node.

Other objects and advantages of the present disclosure will become apparent from the description below and will be clearly understood through embodiments of the present disclosure. It is also to be easily understood that the objects and advantages of the present disclosure may be realized by means of the appended claims and a combination thereof

According to an embodiment of the present disclosure, a method for content caching in an individual node constituting a named data networking (NDN) system includes: receiving first data, which corresponds to a first data request interest, and a node count from a previous node; determining, based on a cache level, whether or not to cache the first data in its contents store (CS); and based on a determination result, storing or not storing the first data in the CS and delivering the first data to a next node, and the cache level means a priority of storing the first data in the CS.

According to an embodiment of the present disclosure, a method for content caching in an individual node constituting a named data networking system further includes delivering the first data to a next node without storing the first data in the CS, when the node count exceeds the cache level.

According to an embodiment of the present disclosure, a method for content caching in an individual node constituting a named data networking system further concludes storing the first data in the CS and delivering to a next node, when the node count is equal to or below the cache level.

According to an embodiment of the present disclosure, in a method for content caching in an individual node constituting a named data networking system, the cache level means a product of the node count and a reciprocal of a cache hint.

According to an embodiment of the present disclosure, in a method for content caching in named data networking, when the cache hint is a specific value, an individual node stores the first data in its CS.

According to an embodiment of the present disclosure, in a method for content caching in named data networking, when the cache level is a specific value, the first data is not stored in a CS of a corresponding node and is delivered to a consumer.

According to an embodiment of the present disclosure, in a method for content caching in named data networking, a node receiving the first data from a previous node reduces the node count.

According to an embodiment of the present disclosure, in a method for content caching in named data networking, an individual node increases a node count for the interest which is received.

According to an embodiment of the present disclosure, a method for content caching in named data networking further includes: when a new node is added at a request of a new consumer, setting, by the new node, a node count and delivering the node count to a next node; when receiving a first data request interest from the new node, returning, by the next node, the first data stored in its CS to the new node; and determining, by the new node, whether or not to cache the first data in its CS based on a cache level.

According to an embodiment of the present disclosure, a method for content caching in named data networking further includes storing, by the new node, the first data in its CS and delivering to a next node, when the node count is equal to or below the cache level.

According to an embodiment of the present disclosure, a method for content caching in named data networking includes: delivering, by a first node that receives a first data request interest from a first consumer, the first data request interest to a second node; delivering, by the second node, the first data request interest to a third node; delivering, by a fourth node that receives a second data request interest from a second consumer, the second data request interest to the second node; delivering, by the third node that receives the first data request interest and first data corresponding to the second data request interest from a producer, the received first data to the second node; and checking, by the second node, a PIT level, storing the first data in its CS and delivering the PIT level and the first data to a next node, and the PIT level means the number of consumers requesting the first data.

According to an embodiment of the present disclosure, a method for content caching in named data networking further includes: setting, by a current node corresponding to the next node, a cache level to a specific value based on the PIT level; and checking, by the current node, the cache level and delivering the first data to a next node without storing the first data in its CS.

According to an embodiment of the present disclosure, in a method for content caching in named data networking, the PIT level has a higher priority than the cache level.

According to an embodiment of the present disclosure, a method for content caching in named data networking further includes: calculating, by the third node that receives first data from a producer, a cache level; and determining, based on a node count and the cache level, whether or not to cache the first data in a CS.

According to an embodiment of the present disclosure, a method for content caching in named data networking further includes delivering, by the third node, the first data to a next node without storing the first data in its CS, when the node count exceeds the cache level.

According to an embodiment of the present disclosure, in a method for content caching in named data networking, when a node corresponding to a new consumer is added, the second node registers only an interface for the added node to a PIT entry.

According to an embodiment of the present disclosure, in a method for content caching in named data networking, an individual node increases a node count for the interest which is received.

According to an embodiment of the present disclosure, in a method for content caching in named data networking, the PIT level is proportional to the number of nodes added to the second node.

According to an embodiment of the present disclosure, in a method for content caching in named data networking, the producer provides the PIT level for the first data.

According to an embodiment of the present disclosure, in a content caching system consisting of a plurality of nodes in named data networking, an individual node of the plurality of nodes includes: a CS unit configured to store data about an interest request; a PIT unit configured to process the data about the interest request and to manage an interface accessing another node; an FIB unit configured to determine, based on a data name contained in the interest request, an interface to which forwarding is to be performed; and a controller configured to control the CS unit, the PIT unit and the FIB unit, to set a node count, to generate a cache level and to store the data in a CS according to at least one of a PIT level and the cache level.

According to an embodiment of the present disclosure, as an individual node determines, based on a node count and a cache level, whether or not to store data in its CS and, based on a determination result, stores the data in the CS or does not store and delivers the data to a next node, it is possible to prevent data from being stored in a CS of a whole network node, and as data is stored in a node nearest to a user, it is possible to improve the efficiency of a network.

According to another embodiment of the present disclosure, when a consumer is added to a specific node, as a PIT level is designated and data is stored in a CS of a node adjacent to a consumer requesting data based on a PIT level and a PIT frequency of a node, it is possible to store data in a CS of a node in which a data request from a user frequently occurs and thus to improve the efficiency of a network.

Effects obtained in the present disclosure are not limited to the above-mentioned effects, and other effects not mentioned above may be clearly understood by those skilled in the art from the following description.

### BRIEF DESCRIPTION OF THE DRAWINGS

FIG. 1 is a view illustrating an NDN data processing flow according to an embodiment of the present disclosure.

FIG. 2 is a view illustrating a block diagram of an individual node according to an embodiment of the present disclosure.

FIG. 3 is a view illustrating an interest structure according to an embodiment of the present disclosure.

FIG. 4 is a view illustrating a structure of a data packet according to an embodiment of the present disclosure.

FIG. 5 is a view illustrating interest and data processing according to an embodiment of the present disclosure.

FIG. 6 is a view illustrating a CS node setting according to a cache level, in accordance with an embodiment of the present disclosure.

FIG. 7 is a view illustrating a CS node setting when there is CS matching due to addition of a node, according to an embodiment of the present disclosure.

FIG. 8 is a view illustrating a CS node setting according to a PIT level, in accordance with an embodiment of the present disclosure.

FIG. 9 is a view illustrating a CS node setting according to a PIT level, in accordance with an embodiment of the present disclosure.

FIG. 10 is a view illustrating a CS node setting process according to a cache level, in accordance with an embodiment of the present disclosure.

FIG. 11 is a view illustrating a CS node setting process according to a PIT level, in accordance with an embodiment of the present disclosure.

FIG. 12 is a view illustrating a temporary storage device of contents according to an embodiment of the present disclosure.

### DETAILED DESCRIPTION

Hereinafter, embodiments of the present disclosure will be described in detail with reference to the accompanying drawings, which will be easily implemented by those skilled in the art. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Also, in the drawings, parts not related to the description of the present disclosure are omitted, and like parts are designated by like reference numerals.

In the present disclosure, components that are distinguished from each other are intended to clearly illustrate respective features, which does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. Also, embodiments that include other components in addition to the components described in the various embodiments are also included in the scope of the present disclosure.

In the present disclosure, components described in the various embodiments are not necessarily essential components, and some may be optional components. Accordingly, embodiments consisting of a subset of the components described in one embodiment are also included within the scope of the present disclosure. Also, embodiments that include other components in addition to the components described in the various embodiments are also included in the scope of the present disclosure.

In the present disclosure, the terms such as first and second are used only for the purpose of distinguishing one component from another, and do not limit the order or importance of components, etc. unless specifically stated otherwise. Accordingly, within the scope of the present disclosure, a first component in one embodiment may be referred to as a second component in another embodiment, and similarly a second component in one embodiment may be referred to as a first component in another embodiment.

When an element is simply referred to as being “connected to” or “coupled to” another element in the present disclosure, it should be understood that the former element is directly connected to or directly coupled to the latter element or the former element is connected to or coupled to the latter element, having yet another element intervening therebetween. In contrast, it should be understood that when an element is referred to as being “directly coupled” or “directly connected” to another element, there are no intervening elements present.

Also, in the present disclosure, unless one drawing showing an embodiment of the present is an alternative to another drawing, the description of each drawing may be applied to other drawings.

Hereinafter, the present disclosure will be described in further detail with reference to the accompanying drawings.

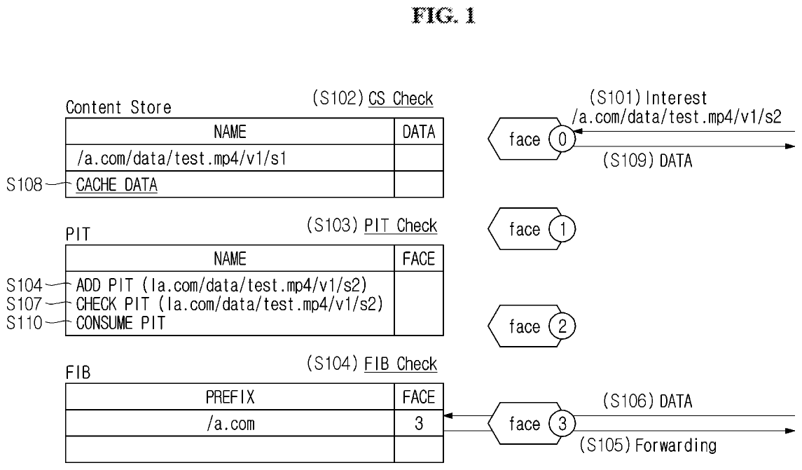

FIG. 1 is a view illustrating an NDN data processing flow according to an embodiment of the present disclosure. Referring to FIG. 1, a node receives an interest (/a.com/data/test.mp4/v1/s2) from a data consumer to face 0 (S101). Herein, face means an interface.

The node checks whether or not its CS has data about the received interest (S102). In case the CS has the data, the node sends the stored data to face 0 and ends the process.

The node checks whether or not there is a PIT for the received interest or not (S103).

In case it has the PIT, the interest and face 0 are added to a corresponding PIT entry. While an entry for a new interest is added to the PIT (/a.com/data/test.mp4/v1/s2, 0), face 3 is retrieved to forward the interest through FIB (S104).

The interest is transmitted out through face 3 retrieved via FIB (S105).

Data, which is a response to the interest, is received from outside (S106). Face 3, which is confirmed through FIB, is utilized.

PIT for the received data is checked (S107). In case there is no PIT information on a corresponding name, the received data is discarded and the process ends.

In case there is PIT information on the name, the received data is stored in the CS (S108). That is, since there is a request for the data, the data is stored in the CS.

The data is transmitted out to face 0 registered in a PIT (S109).

When every processing for the interest is completed, information registered in the PIT is deleted (S110).

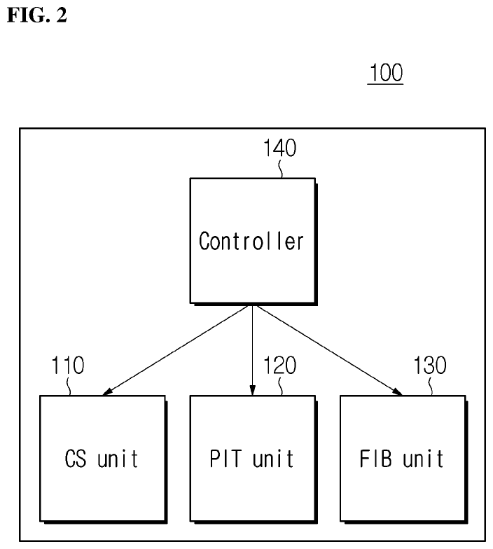

FIG. 2 is a view illustrating a block diagram of an individual node according to an embodiment of the present disclosure.

Referring to FIG. 2, an individual node 100 includes a CS unit 110, a PIT unit 120, an FIB unit 130, and a controller 140.

The CS unit 110 stores data about an interest request. The CS unit 110 functions as a memory that caches the data.

The pending interest table (hereinafter, PIT) unit 120 processes data about an interest request and manages an interface accessing another node.

The forwarding information base (hereinafter, FIB) unit 130 determines an interface to forward based on a data name contained in an interest request.

The controller 140 controls the CS unit 110, the PIT unit 120 and the FIB unit 130.

The controller 140 sets a node count, generates a cache level, and stores the data in the CS unit 110 according to at least one of a PIT level and the cache level.

Hereinafter, the controller 140 will be described in detail. The controller 140 performs contents storage and management.

NDN is configured by a data response to an interest request. Herein, data delivered as a response is cached in a CS of every NDN node on the way to be delivered to a requestor.

The controller 140 provides a hint to cache data in an appropriate node instead of every node on a network by adjusting a level of storing response data. When a data request interest goes through a first node, the count of a controller of nodes is set. A count accumulated until a node receiving a data response is utilized to generate a level.

A level adjusts a cache number on a network as an element for storing a node that will store data.

Hereinafter, cumulative count setting and layer generation will be described.

Each node generates a cumulative count until receiving a data response. When a consumer's request moves to a producer, each node increases a node count.

According to an embodiment of the present disclosure, a content caching system may be implemented using a plurality of nodes.

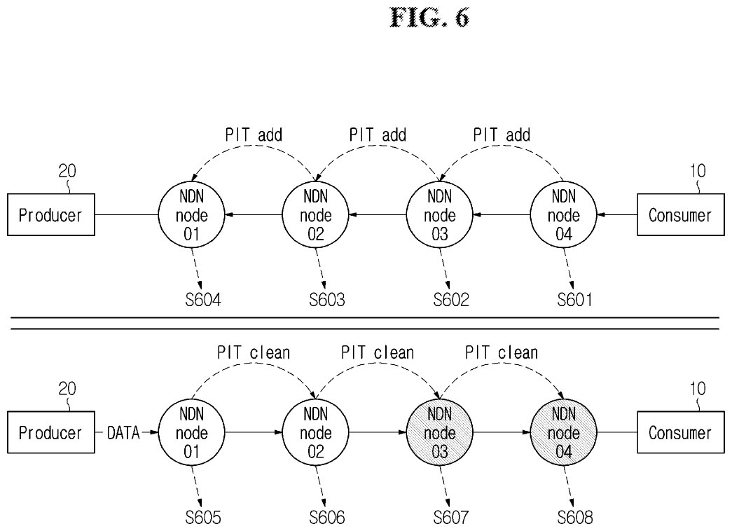

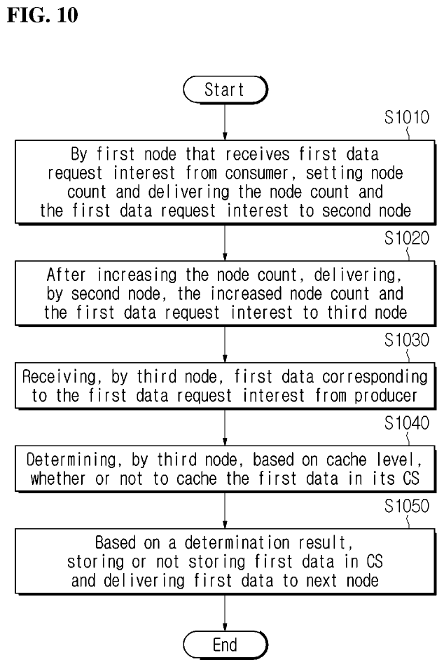

For example, referring to FIG. 6, an individual node of the plurality of nodes includes the CS unit 110, the PIT unit 120, the FIB unit 130, and the controller 140. A plurality of nodes is executed by the control logic of FIG. 10.

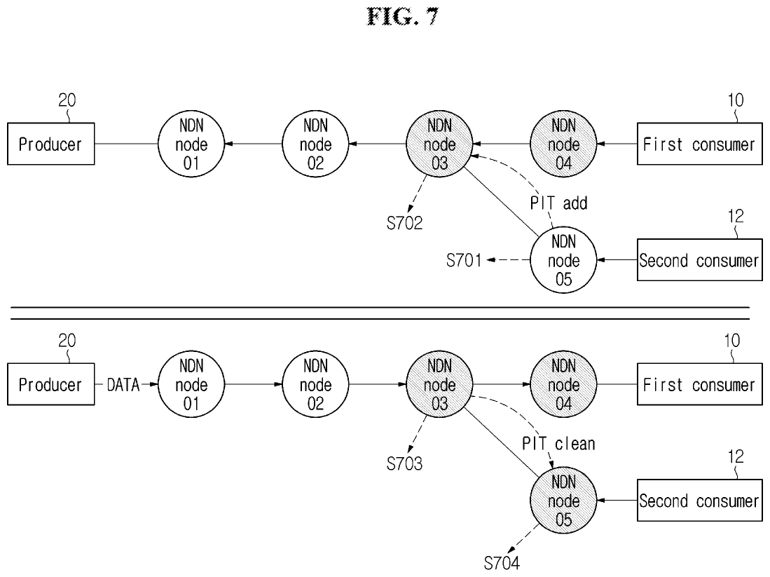

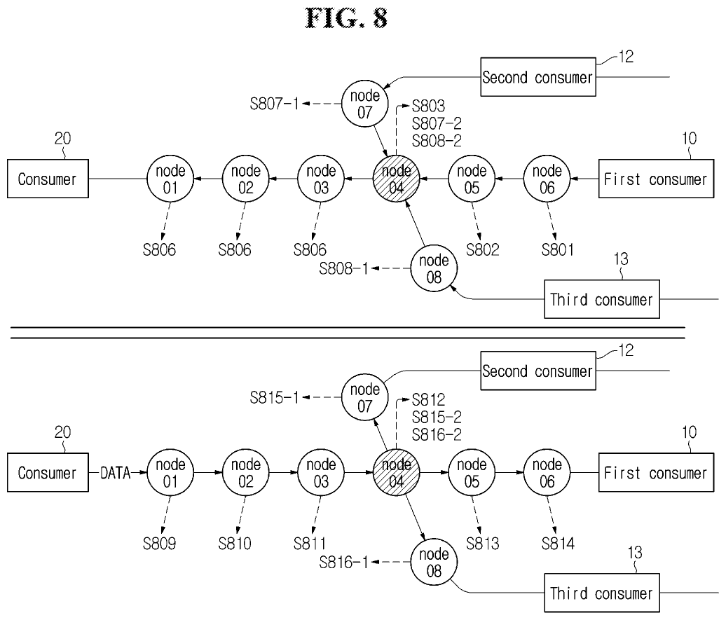

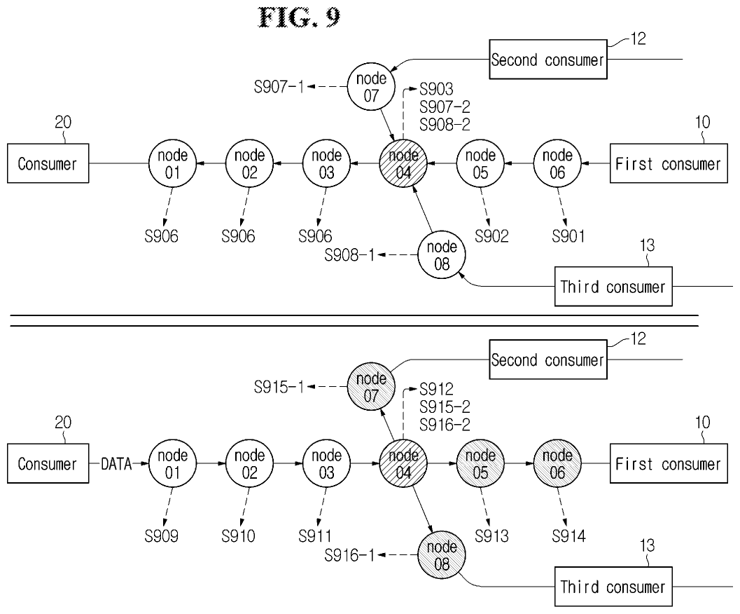

The embodiments of FIG. 7, FIG. 8 and FIG. 9 may be implemented by the same method as FIG. 6.

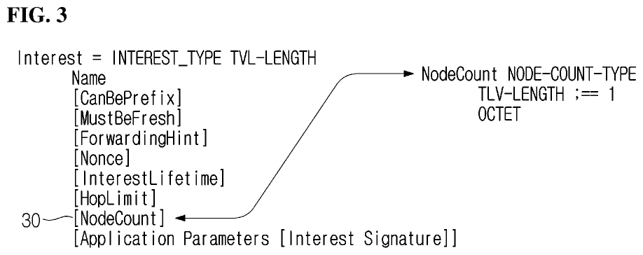

FIG. 3 is a view illustrating an interest structure according to an embodiment of the present disclosure.

Referring to FIG. 3, an interest configuration and a node count setting will be described.

A data request is executed by transmitting an interest and utilizes a node count 30. The node count 30 means a hop number for which an interest is delivered. The node count 30 increases an encoding value by one whenever an interest is delivered to another node.

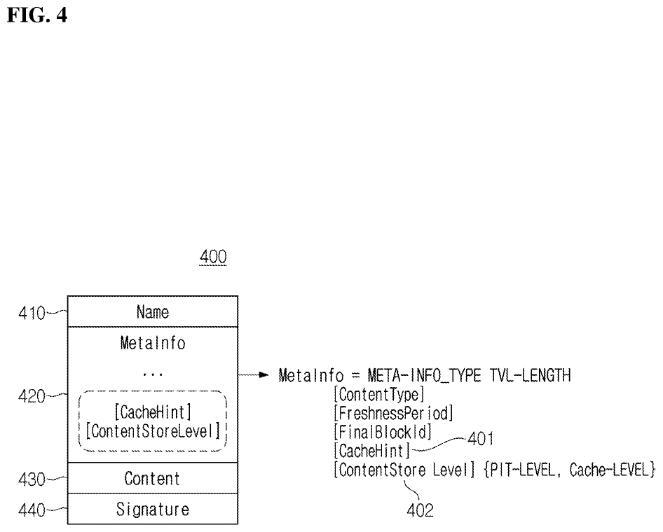

FIG. 4 is a view illustrating a structure of a data packet according to an embodiment of the present disclosure.

Referring to FIG. 4, a data packet configuration will be described.

A data packet 400 includes a name 410, meta information 420, a content 430, and a signature 440.

The meta information 420 includes a cache hint 401 and a content store level (CSL, ContentStoreLevel) 402. The content store level 402 includes a PIT level and a cache level. The content store level 402 is generated as a pair of a PIT level and a cache level.

A node, which receives a data response, sets a cache level based on a cumulative node count. When providing data, a producer may set a cache hint.

Cache level=node count×1/cache hint. That is, a cache level means a product of a node count and a reciprocal of a cache hint.

When a cache level is 0, data is not stored in a CS but is skipped.

When a cache hint is 1, since a cache level and a node count become identical with each other, every node stores data in its CS.

Hereinafter, a PIT level setting will be described.

A PIT level means a number of consumers requesting data in a specific node. Accordingly, when a PIT level is high, it means that there are many consumers requesting data in a specific node, and when a PIT level is low, it means that there are a small number of consumers requesting data in a specific node.

When providing data, a producer may set a PIT level.

A PIT level has a highest priority among all elements. A PIT level has a higher priority than a cache level. When a PIT level condition is satisfied, data is cached in a CS irrespective of a cache level.

When CS caching is completed due to a PIT level, a cache level is set to 0.

A cache level setting becomes different according to a strategy, and an existing cache level may be applied. In this case, CS storage at a PIT level and CS storage for a cache level are performed at the same time.

Data delivery will be described below.

In a node which has completed data delivery, a node count decreases.

When a node count and a cache level are compared and the node count exceeds the cache level, data is not stored in CS.

When a node count and a cache level are compared and the cache level is equal to or greater than the node count, data is stored in CS.

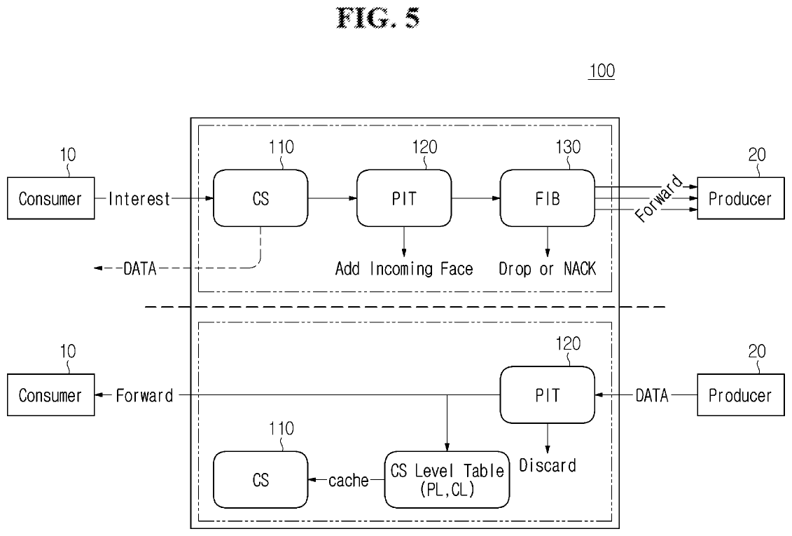

FIG. 5 is a view illustrating interest and data processing according to an embodiment of the present disclosure.

Referring to FIG. 5, an NDN network will be described.

An NDN network consists of a plurality of NDN routers and an NDN node capable of computing.

The consumer 10 transmits an interest for desired data to the node 100.

Every node 100 includes the controller 140.

While an interest of the consumer 10 is being delivered to the producer 20, a node count increases. Specifically, the node count increases by one whenever the interest passes a node.

The producer 20 provides a cache hint capable of setting caching for data to a next node. The producer 20 provides a PIT level for data to a next node.

The consumer 10 requests data through an interest and knows a data name.

Each node 100 increases a node count for a received interest by one.

Each node 100 adds a PIT entry for a received interest.

The producer 20 provides data about an interest to a next node.

The producer 20 configures a data block by setting a cache hint for response data. The producer 20 configures a data block by setting a PIT level for response data.

The PIT level and the cache hint have a default value of 0.

A node designates a content store level by using a PIT level and a cache level and adds and delivers this value to data meta information.

A node sets a cache level based on a cache hint of data and fills a CS level table.

When both a PIT level and a cache level have a value of 0, a node caches data in its CS. The value of a PIT level and a cache level may be modified in some cases.

A node caches data in a CS according to a content store level.

A PIT level has priority over a cache level. A PIT level means a threshold for the number of interfaces of a PIT entry. When there are many interfaces, it means that there are many consumers requesting data.

FIG. 6 is a view illustrating a CS node setting according to a cache level, in accordance with an embodiment of the present disclosure.

Referring to FIG. 6, an NDN node (node04), which receives a request interest of the consumer 10, confirms, through a controller, that there is no CS entry, sets a node count and sets an initial count to 1 and then delivers it to a next node (S601).

Whenever moving from a current node to a next node, a PIT is added.

Herein, when an initial network is configured, the CS of each node is all empty. That is, it is registered to a PIT entry in an empty state. Hereinafter, the state of an individual node is operated in the same state as above. A node count of a consumer node is 0. A node count of node04 is 1.

A node (node03), which receives a data request interest from a previous node (node04), confirms, through a controller, that there is no CS entry, increases a node count by one so that a cumulative count becomes 2, and delivers data to a next node (node02) (S602).

A node count of node03 is 2.

A node (node02), which receives a data request interest from a previous node (node03), confirms, through a controller, that there is no CS entry, increases a node count by one so that a cumulative count becomes 3, and delivers data to a next node (S603).

A node count of node02 is 3.

A node (node01), which receives a data request interest from a previous node (node02), confirms, through a controller, that there is no CS entry, increases a node count by one so that a cumulative count becomes 4, and delivers data to a next node (S604).

A node count of node01 is 4.

The controller 140 of node01, which receives data from the producer 20, determines whether or not to cache the data in a CS through the following procedure (S605).

A cache hint designated by the producer 20 is 2.

A cache level is calculated.

It is calculated by the formula: Cache level=node count×1/cache hint.

In node01, since a node count is 4 and a cache hint is 2, a cache level is 2.

A node count of a node receiving data and a cache level are compared. Based on a comparison result, it is determined whether or not to store.

For example, when the node count exceeds the cache level, data is not stored in a CS of the node and is delivered to a next node.

When the node count is equal to or below the cache level, data is stored in the CS of the node and is delivered to a next node.

Based on a comparison result, meta information is configured including a content store level.

In node01, since the node count of 4 exceeds the cache level of 2, data is not stored in the CS of node01 and is delivered to a next node (node02).

The controller of node02 receiving data from node01 checks a cache level and compares it with a node count. Based on a comparison result, since the node count is greater than the cache level, data is not stored in a CS and is delivered to a next node (node03) (S606).

In node02, since the node count of 3 exceeds the cache level of 2, data is not stored in the CS of node02 and is delivered to a next node (node03).

The controller of node03 receiving data from node02 checks a cache level and compares it with a node count. Based on a comparison result, since the node count is equal to or below than the cache level, data is stored in a CS and is delivered to a next node (node04) (S607).

In node03, the node count of 2 is equal to or below the cache level of 2, data is stored in a CS of node03 and is delivered to a next node (node04).

According to an embodiment of the present disclosure, a controller of node03 may delete data stored in a CS according to a node design structure. For example, in node03, when a use rate of data is lower than a preset threshold, data stored in a CS may be deleted.

That is, when the use rate of data is low in a specific node, the specific node may delete the data on its own and thus may prevent unnecessary data from being stored in the CS.

When receiving data from node03, node04 checks a cache level and compares it with a node count. Based on a comparison result, since the cache level exceeds the node count, data is stored in a CS and is delivered to the consumer 10 that is a next node (S608).

According to the present disclosure, among node01 to node04, in the cases of node01 and node02, since a node count exceeds a cache level, data is not stored in a CS of an individual node. n the case of node03, since a cache level is 2 and a node count is 2, data is stored in a CS of node03.

In the case of node04, since a cache level is 2 and a node count is 1, data is stored in a CS of node04.

In other words, data is stored only in node03 and node04, and data is not stored in the remaining nodes.

In the case of node04, as there is a data request from the consumer 10 nearby, storing data in the CS of node04, not in a CS of any other nodes, may enhance the network transmission efficiency.

Node03 is the second nearest node to the consumer 10 after node04. Compared to other nodes, storing data in the CS of node03 may enhance the network transmission efficiency.

According to the present disclosure, as the problem of caching data in the CS of every node in a network may be prevented, the CS storage efficiency of the network may be improved. Furthermore, as data can be cached in a node nearest to a user, the network efficiency may be improved.

FIG. 7 is a view illustrating a CS node setting when there is CS matching due to addition of a node, according to an embodiment of the present disclosure.

This embodiment is an example of providing data cached in a node while a consumer's request interest is being delivered. The basic procedure is the same as in FIG. 6.

In case a new node (node05) is added at a request of a second consumer 12, that is, a new consumer, the node (node05) sets a node count and delivers the node count to a next node (S701).

Specifically, when configuring an initial network, the CS of each node is all empty, which is registered to a PIT entry. The node count of the second consumer node 12 is 0.

A node count of node05 is 1.

A node (node03), which receives a data request interest from a previous node (node05), confirms, through a controller, that there is a CS entry, and returns data through its CS (S702).

There is matched data in a CS entry of node03.

As node03 already has data about the interest, the data is returned (S703).

Herein, the cache hint designated by the producer 20 is still 2.

The controller 140 of node05 receiving data from node03 checks a cache level and compares it with a node count. Based on a comparison result, since the cache level is greater than the node count, data is stored in a CS and is delivered to a next node (S704).

The controller of node05 confirms that the cache level is 2, and since the cache level of 2 is greater than the node count of 1, node05 stores data in its CS and delivers the data to node03.

According to the present disclosure, data is stored in the CSs of node03 and node04, and data is stored in a CS of node05 that is newly added. This is because storing data in a CS of a node nearest to the consumer 12 may enhance the network efficiency.

FIG. 8 is a view illustrating a CS node setting according to a PIT level, in accordance with an embodiment of the present disclosure.

Referring to FIG. 8, when there are multiple consumer requests, a PIT level of a contents store level is utilized to select a node to cache according to the number of faces for a PIT entry of a node.

An NDN node (node06), which receives a request interest of a first consumer 11, confirms, through a controller, that there is no CS entry, sets a node count to 1, that is, an initial count, and then delivers a data request interest to a next node (S801).

When an initial network is configured, the CS of each node is all empty. This is registered to a PIT entry. This applies to every individual node.

The node count of the first consumer node 11 is 0. A node count of node06 is 1.

node05 confirms, through a controller, that there is no CS entry, increases the node count and then delivers the data request interest and the node count to a next node (node04) (S802).

A node count of node05 is 2.

node04 confirms, through a controller, that there is no CS entry, increases the node count by one and then delivers the data request interest and the node count to a next node (node03) (S803).

A node count of node04 is 3.

node03 confirms, through a controller, that there is no CS entry, increases the node count by one and then delivers the data request interest and the node count to a next node (node02) (S804).

A node count of node03 is 4.

node02 confirms, through a controller, that there is no CS entry, increases the node count by one and then delivers the data request interest and the node count to a next node (node01) (S805).

A node count of node02 is 5.

node01 confirms, through a controller, that there is no CS entry, increases the node count by one and then delivers the data request interest and the node count to the producer node 20 which is a next node (S806).

A node count of node01 is 6.

A node (node07), which receives a data request interest from the second consumer node 12, confirms, through a controller, that there is no CS entry, increases a node count by one and then delivers it to a next node (node04) (S807-1).

When an initial network is configured, the CS of each node is all empty. The node count of node07 is 1 because of a new request.

As node04 has already a corresponding PIT entry, only a face for node07 is registered (S807-2).

A node (node08), which receives a data request interest from a third consumer 13, confirms, through a controller, that there is no CS entry, increases a node count by one and then delivers it to a next node (node04) (S808-1).

A node count of node08 is 1.

As node04 has already a corresponding PIT entry, only a face for node08 is registered (S808-2).

The controller of a node(node01), which receives data from the producer 20, determines whether or not to cache the data in a CS through the following procedure (S809). Hereinafter, the controller of an individual node also executes the same procedure as node01.

A cache hint designated by the producer 20 is 2. A cache level is calculated. The cache level becomes 3.

A node count of a node receiving data and a cache level are compared. When the node count exceeds the cache level, the node does not store the data in its CS and delivers the data to a next node.

In node01, since the node count is 6 and the cache level is 2, node01 does not store data in its CS and delivers the data to a next node(node02).

node02 checks a cache level and compares the cache level with the node count (S810). Based on a comparison result, since the node count is greater than the cache level, data is not stored in a CS and is delivered to a next node(node03).

In node02, since the node count is 5 and the cache level is 2, node02 does not store the data in its CS and delivers the data to a next node(node03).

node03 checks a cache level and compares the cache level with the node count. Based on a comparison result, since the node count is greater, the data is not stored in a CS and is delivered to a next node (S811).

In node03, since the node count is 4 and the cache level is 2, node03 does not store the data in its CS and delivers the data to a next node(node04).

node04 checks a PIT level and stores the PIT level in a CS (S812).

A PIT level designated by the producer is 3. That is, a total of 3 faces are registered to a PIT. Here, the faces mean node05, node07, and node08.

A PIT level has a higher priority than a cache level. An individual node sets a cache level to 0, when a CS is set based on a PIT level. In case a cache level is 0, storing data in a CS is skipped.

node05 checks a cache level, and since the cache level is 0, node05 does not store data in a CS and delivers the data to a next node(node06) (S813).

node06 checks a cache level, and since the cache level is 0, node06 does not store data in a CS and delivers the data to the first consumer 11 that is a next node (S814).

node07, which receives data from node04, checks a cache level and delivers the data to the second consumer 12 that is a next node (S815-1). As the cache level is 0, the data is not stored in a CS.

The remaining process is the same as the order of the step S812 (S815-2).

node08, which receives data from node04, checks a cache level and delivers the data to the third consumer 13 that is a next node (S816-1). As the cache level is 0, the data is not stored in a CS.

The remaining process is the same as the order of the step S812 (S816-2).

According to the present disclosure, among node01 to node08, in the cases of node01, node02 and node3, since a node count exceeds a cache level, data is not stored in a CS of an individual node.

In the case of node04, a PIT level is designated as 3, and when a CS is set due to the PIT level, a cache level is set to 0. Accordingly, in the cases of node05, node06, node07 and node08, since the cache level is 0, data is not stored in a CS of an individual node.

In other words, data is stored only in node04, and data is not stored in the remaining nodes.

In the case of node04, nearby 3 faces including node05, node07 and node08 are registered in a PIT. A PIT level is 3. Accordingly, as there are data requests from the first consumer, the second consumer and the third consumer, storing data in the CS of node04, not in a CS of any other nodes, may enhance the network transmission efficiency. Herein, the data requested by the first consumer, the second consumer and the third consumer means identical data.

According to the present disclosure, a reasonable CS location is naturally configured since data can be stored in a CS of a node in which the request of the data frequently occurs. In addition, storage efficiency may be enhanced since data hardly requested by consumers can be deleted from a CS.

FIG. 9 is a view illustrating a CS node setting according to a PIT level, in accordance with an embodiment of the present disclosure. This case is an exceptional case of FIG. 8, in which a cache level is not 0 according to a PIT level but retains a specific value at a consumer's request.

The previous order is the same as the embodiment of FIG. 8.

Referring to FIG. 9, a controller of node04 checks a PIT level and stores it in a CS. A PIT level designated by the producer is 3.

A total of 3 faces are registered to a PIT. Specifically, node05, node07, and node08 are registered.

Generally, a PIT level has a higher priority than a cache level. Accordingly, a CS is set by a PIT level, but a cache level is set to 3 at a producer's request.

node05 (S913), node06 (S914), node07 (S915-1), and node08 (S916-1), which receive data from node04, check a cache level and compare it with a node count. Based on a comparison result, since the cache level is greater than the node count, data is stored in a CS and is delivered to a next node.

Specifically, a node count of a node receiving data and a cache level are compared.

When the cache level is equal to or greater than the node count, data is stored in a CS of a current node and is delivered to a next node.

According to the present disclosure, among node01 to node08, in the cases of node01, node02 and node3, since a node count exceeds a cache level of 3, data is not stored in a CS of an individual node.

In the case of node04, a PIT level is designated as 3, and originally when a CS is set due to the PIT level, a cache level is set to 0. However, according to an exceptional case, in the cases of node05, node06, node07 and node08, since the cache level is 3, data is stored in a CS of an individual node.

That is, data is stored in node04, and data is also stored in node05, node06, node07 and node08.

In the case of node04, nearby 3 faces including node05, node07 and node08 are registered in a PIT. Accordingly, in case there are data requests from the first consumer 11, the second consumer 12 and the third consumer 13, when data is stored in node05, node06, node07 and node08, data may be delivered to an individual consumer. Accordingly, network transmission efficiency may be enhanced.

In recent times, massive multimedia files are data that are most frequently used in the Internet. Technical advances make the performance of terminals exponentially developed, and this has created the environment in which massive data are generated in abundance. High-definition contents services are already provided mainly by contents providers. Such data shows a congested form of traffic in a specific section, and most services support load balancing and high-definition data by configuring cache servers.

As for the feature of NDN, since a CS is configured in every node, no specific cache server is needed. However, a current full-caching model caches data using a whole storage of a node and thus may aggravate the burden of storage.

According to the present disclosure, as CS nodes are distributed by designating a level based on a node count and by designating a node that is to cache data, the network efficiency may be improved.

According to the present disclosure, as a PIT level is designated and PIT frequencies of nodes are compared so that caching is performed near a consumer generating a same interest many times, CS nodes may be distributed and thus the network efficiency may be improved.

FIG. 10 is a view illustrating a CS node setting process according to a cache level, in accordance with an embodiment of the present disclosure. The present disclosure is implemented by a content caching system consisting of a plurality of nodes.

Referring to FIG. 10, a first node, which receives a first data request interest from a consumer, sets a node count and delivers the node count and the first data request interest to a second node (S1010).

The second node increases the node count and then the increased node count and the first data request interest to a third node (S1020).

The third node receives first data corresponding to the first data request interest from a producer (S1030).

The third node determines, based on a cache level, whether or not to cache the first data in its CS (S1040).

Based on a determination result, the first data is stored or not stored in the CS and is delivered to a next node (S1050).

Herein, the cache level means a priority order for storing the first data in the CS.

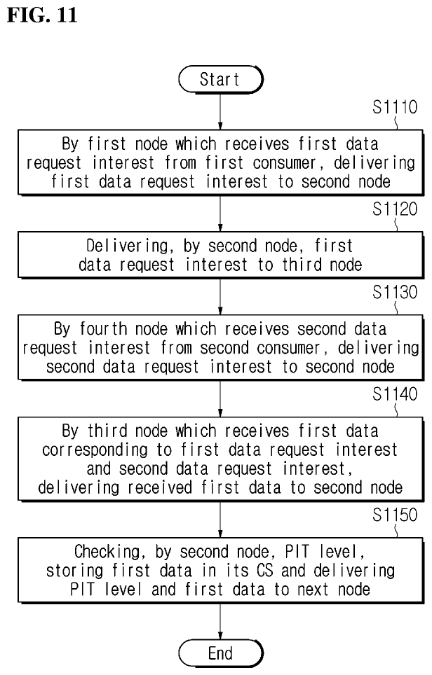

FIG. 11 is a view illustrating a CS node setting process according to a PIT level, in accordance with an embodiment of the present disclosure. The present disclosure is implemented by a content caching system consisting of a plurality of nodes.

Referring to FIG. 11, a first node, which receives a first data request interest from a first consumer, delivers the first data request interest to a second node (S1110).

The second node delivers the first data request interest to a third node (S1120).

A fourth node, which receives a second data request interest from a second consumer, delivers the second data request interest to the second node (S1130).

The third node, which receives first data corresponding to the first data request interest and the second data request interest, delivers the received first data to the second node (S1140).

The second node checks a PIT level, stores the first data in its CS and delivers the PIT level and the first data to a next node (S1150).

Herein, the PIT level means a degree to which a consumer requests the first data.

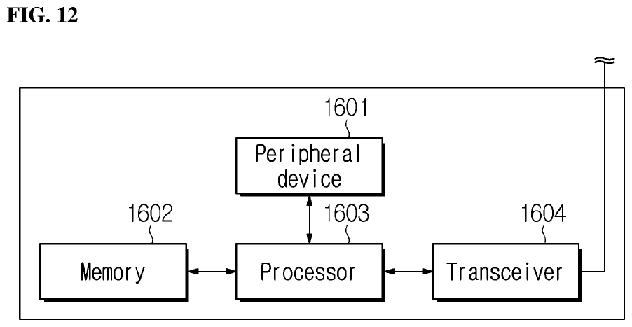

FIG. 12 is a view illustrating a configuration of a content caching device according to an embodiment of the present disclosure.

Referring to FIG. 12, a content caching device will be described. The content caching device includes a device 1600. The device 1600 may include a memory 1602, a processor 1603, a transceiver 1604 and a peripheral device 1601. In addition, for example, the device 1600 may further include another configuration and is not limited to the above-described embodiment. Herein, for example, a device may be an apparatus operating based on the above-described NDN system.

More specifically, the device 1600 of FIG.12 may be an illustrative hardware/software architecture such as an NDN device, an NDN server, and a content router. Herein, as an example, the memory 1602 may be a non-removable memory or a removable memory. In addition, as an example, the peripheral device 1601 may include a display, GPS or other peripherals and is not limited to the above-described embodiment.

In addition, as an example, like the transceiver 1604, the above-described device 1600 may include a communication circuit. Based on this, the device 1600 may perform communication with an external device.

In addition, as an example, the processor 1603 may be at least one of a general-purpose processor, a digital signal processor (DSP), a DSP core, a controller, a micro controller, application specific integrated circuits (ASICs), field programmable gate array (FPGA) circuits, any other type of integrated circuit (IC), and one or more microprocessors related to a state machine. In other words, it may be a hardware/software configuration playing a controlling role for controlling the above-described device 1600.

Herein, the processor 1603 may execute computer-executable commands stored in the memory 1602 in order to implement various necessary functions of node. As an example, the processor 1603 may control at least any one operation among signal coding, data processing, power controlling, input and output processing, and communication operation. In addition, the processor 1603 may control a physical layer, an MAC layer and an application layer. In addition, as an example, the processor 1603 may execute an authentication and security procedure in an access layer and/or an application layer but is not limited to the above-described embodiment.

In addition, as an example, the processor 1603 may perform communication with other devices via the transceiver 1604. As an example, the processor 1603 may execute computer-executable commands so that a node may be controlled to perform communication with other nodes via a network. That is, communication performed in the present invention may be controlled. As an example, other nodes may be an NDN server, a content router and other devices. As an example, the transceiver 1604 may send a RF signal through an antenna and may send a signal based on various communication networks.

In addition, as an example, MIMO technology and beam forming technology may be applied as antenna technology but are not limited to the above-described embodiment. In addition, a signal transmitted and received through the transceiver 1604 may be controlled by the processor 1603 by being modulated and demodulated, which is not limited to the above-described embodiment.

The various embodiments of the disclosure are not intended to be all-inclusive and are intended to illustrate representative aspects of the disclosure, and the features described in the various embodiments may be applied independently or in a combination of two or more.

In addition, the various embodiments of the present disclosure may be implemented by hardware, firmware, software, or a combination thereof. In the case of hardware implementation, one or more application specific integrated circuits (ASICs), digital signal processors (DSPs), digital signal processing devices (DSPDs), programmable logic devices (PLDs), field programmable gate arrays A general processor, a controller, a microcontroller, a microprocessor, and the like may be used for implementation. For example, the present disclosure may be implemented by a type of program stored in a non-transitory computer readable medium that may be used on a terminal or an edge or be implemented by a type of program stored in a non-transitory computer-readable medium that may be used on an edge or a cloud. In addition, the present disclosure may also be implemented in various combinations of hardware and software.

The scope of the present disclosure includes software or machine-executable instructions (for example, an operating system, applications, firmware, programs, etc.) that enable operations according to the methods of various embodiments to be performed on a device or computer, and a non-transitory computer-readable medium in which such software or instructions are stored and are executable on a device or computer.

It will be apparent to those skilled in the art that various substitutions, modifications and changes are possible are possible without departing from the technical features of the present disclosure. It is therefore to be understood that the scope of the present disclosure is not limited to the above-described embodiments and the accompanying drawings.

What is claimed is:

1. A method for content caching in an individual node constituting a named data networking (NDN) system, the method comprising:
receiving first data, which corresponds to a first data request interest, and a node count from a previous node;
determining, based on a cache level, whether or not to cache the first data in its contents store (CS); and
based on a determination result, storing or not storing the first data in the CS and delivering the first data to a next node,
wherein the cache level means a priority of storing the first data in the CS.

2. The method of claim 1, further comprising delivering the first data to a next node without storing the first data in the CS, when the node count exceeds the cache level.

3. The method of claim 1, further comprising storing the first data in the CS and delivering the first data to a next node, when the node count is equal to or below the cache level.

4. The method of claim 1, wherein the cache level means a product of the node count and a reciprocal of a cache hint.

5. The method of claim 4, wherein an individual node stores the first data in its CS, when the cache hint is a specific value.

6. The method of claim 1, wherein the first data is not stored in a CS of an individual node and is delivered to a consumer, when the cache level is a specific value.

7. The method of claim 1, wherein an individual node decreases a node count for the received first data.

8. The method of claim 1, wherein an individual node increases a node count for the received first data request interest.

9. The method of claim 1, comprising:
when a new node is added at a request of a new consumer, setting, by the new node, a node count and delivering the node count to a next node;
when receiving a first data request interest from the new node, returning, by the next node, the first data stored in its CS to the new node; and
determining, by the new node, whether or not to cache the first data in its CS, based on a cache level.

10. The method of claim 9, further comprising storing, by the new node, the first data in its CS and delivering the first data to a next node, when the cache level is equal to or greater than the node count.

11. A method for content caching in an individual node constituting a named data networking (NDN) system, the method comprising:
receiving, from a previous node, first data corresponding to a first data request interest which is individually received from a plurality of consumers; and
checking a pending interest table (PIT) level, storing the first data in its contents store (CS) and delivering the PIT level and the first data to a next node,
wherein the PIT level means a number of consumers requesting the first data.

12. The method of claim 11, further comprising:
setting, by the next node, a cache level to a specific value based on the PIT level; and
checking, by the next node, the cache level and delivering the first data to another node, which is different from the next node, without storing the first data in its CS.

13. The method of claim 12, wherein the PIT level has a higher priority than the cache level.

14. The method of claim 11, further comprising: calculating the cache level at which the first data is received from a producer; and
determining, based on a node count and the cache level, whether or not to cache the first data in a CS.

15. The method of claim 14, further comprising delivering the first data to a next node without storing the first data in its CS, when the cache level is below the node count.

16. The method of claim 11, further comprising, when a node corresponding to a new consumer is added, registering only an interface for the added node to a PIT entry.

17. The method of claim 11, wherein an individual node increases a node count for the received first data request interest.

18. The method of claim 11, wherein the PIT level is proportional to a number of nodes added to a specific node.

19. The method of claim 11, wherein a producer provides the PIT level for the first data.

20. An individual node constituting a named data networking system, the individual node comprising:
a content store (CS) unit configured to store data about an interest request;
a pending interest table (PIT) unit configured to process the data about the interest request and to manage an interface accessing another node;
a forwarding information base (FIB) unit configured to determine, based on a data name contained in the interest request, an interface to which forwarding is to be performed; and
a controller configured to:
control the CS unit, the PIT unit and the FIB unit,
set a node count,
generate a cache level, and
store the data in a CS according to at least one of a PIT level and the cache level,
wherein the cache level means a priority of storing the first data in the CS.
